(19) United States
(12) Patent Application Publication
(10) Pub. No.: US 2014/0297005 A1
(43) Pub. Date: Oct. 2, 2014

(54) INSTRUMENT CONTROLLING SYSTEM

(71) Applicant: Azbil Corporation, Tokyo (JP)

(72) Inventor: Yoshinori MONAKA, Tokyo (JP)

(73) Assignee: Azbil Corporation, Tokyo (JP)

(21) Appl. No.: 14/225,699

(22) Filed: Mar. 26, 2014

(30) Foreign Application Priority Data
Mar. 28, 2013 (JP) 2013-070020

(51) Int. Cl. G05B 15/02

(52) U.S. Cl. CPC G05B 15/02
USPC 700/83

(57) ABSTRACT

A setup information controlling device connectable to an instrument, which is subject to control, and an instrument monitoring terminal that is provided with the instrument and stores setup information that includes a protocol for communicating with another instrument. The setup information controlling device includes an acquiring portion that acquires the setup information from the instrument monitoring terminal, a storing portion that stores the setup information that has been acquired by the acquiring portion, and a transmitting portion that transmits the setup information, corresponding to an address, to the instrument that is connected to that address, which corresponds to the setup information stored in the storing portion.

### CROSS REFERENCE TO RELATED APPLICATION

This application claims priority under 35 U.S.C. §119 to Japanese Patent Application No. 2013-070020, filed on Mar. 28, 2013, the entire content of which being hereby incorporated herein by reference.

### FIELD OF TECHNOLOGY

The present invention relates to an instrument controlling system.

### BACKGROUND

Typically, in a system for controlling manufacturing processes, manufacturing processes are run and controlled by arranging a large number of instruments (for example, sensor instruments and devices such as valve positioners, and the like, in the plant, and collecting into the system the signals sent from these instruments. In recent years, instruments (hereinafter termed “HART communication-compatible instruments”) that are provided with the HART (Highway Addressable Remote Transducer) communication function have been used as the instruments that are arranged within the plant. These HART communication-compatible instruments send and receive signals (hereinafter termed “HART communication signals”) that are produced by superimposing AC signals, wherein logic of digital signals has been converted through assignment to frequency signals of 2200 Hz and 1200 Hz, onto DC signals of between 4 and 20 mA that indicate a measured value or a control value. That is, HART communication-compatible instruments are able to apply and exchange various types of information, in addition to measured values and control values, with devices on the higher-level side.

A system that uses HART communication-compatible instruments is described in, for example, Japanese Unexamined Patent Application Publication 2012-14388. In this system, an input/output instrument that has a HART communication function intermediates the communication between an instrument monitoring device and a plurality of HART communication-compatible instruments. A plurality of such input/output instruments is provided within the system, where setup information that includes the protocols for communicating between the instrument monitoring device and the HART communication-compatible instrument is stored in each individual input/output instrument.

However, when an input/output instrument is swapped due to a fault, or the like, it is necessary for the input/output instrument after the swap to inherit the setup information that had been set in the input/output instrument prior to the swap. In this case, if it were possible to extract the setup information from the input/output instrument from prior to the swap, then it would be possible to reproduce easily the state of the input/output instrument from prior to the swap by transferring, to the input/output instrument after the swap, to be setup information that has been extracted. However, it can be envisioned that, depending on the form of fault, such as the input/output instrument becoming inoperable, it might be impossible to extract the setup information from the input/output instrument. In this case, the setup will have to be done through individual manual operations, which can lead to setup errors. When there is an error in the setup, there is the possibility that this can have an adverse effect on the system as a whole, and thus there is the need to perform the setup operation reliably, to reproduce accurately the state of the input/output instrument prior to the swap.

The present invention is to solve the problem area set forth above with the conventional technology, and an aspect thereof is to provide a setup information controlling device able to reproduce, easily and accurately, setup information for an instrument.

### SUMMARY

A setup information controlling device according to the present invention is connectable to an instrument, which is subject to control, and an instrument monitoring terminal that is provided with the instrument and stores setup information that includes a protocol for communicating with another instrument. The setup information controlling device includes an acquiring portion that acquires the setup information from the instrument monitoring terminal, a storing portion that stores the setup information that has been acquired by the acquiring portion, and a transmitting portion that transmits the setup information, corresponding to an address, to the instrument that is connected to that address, which corresponds to the setup information stored in the storing portion.

The use of this structure enables the setup information controlling device according to the present invention to acquire and store the setup information from the instrument monitoring terminal that stores the setup information of the instrument, and possible to send, to an instrument that is connected at an address that corresponds to that setup information, the setup information that is stored therein, thus making it possible to transfer, easily and reliably, the setup information that was set in an instrument, prior to a swap, to the instrument after the swap, even if the swap is because there is a failure in the instrument.

The acquiring portion may acquire the setup information when the setup information controlling device is turned ON.

This makes it possible to acquire and store the instrument setup information each time the setup information controlling device is started up.

The transmitting portion may transmit the setup information to the applicable instrument when a connection to an instrument that is connected to the address corresponding to the setup information that is stored in the storing portion has been confirmed.

This makes it possible to send the setup information to the instrument whenever the instrument is reconnected to the system.

The present invention enables the provision of a setup information controlling device that enables easy and accurate reproduction of setup information for an instrument.

### BRIEF DESCRIPTIONS OF THE DRAWINGS

FIG. 1 is a diagram illustrating a structure for an instrument control system including a setup information controlling device according to an example.

FIG. 2 is a diagram illustrating a functional structure for the setup information controlling device illustrated in FIG. 1.

FIG. 3 is a sequence chart for explaining the operation of the instrument controlling system illustrated in FIG. 1.

### DETAILED DESCRIPTION

An example according to the present invention will be explained below in reference to the drawings. However, the example explained below is no more than an illustration, and does not exclude various modifications and applications to technologies not explicated below. That is, the present invention can be embodied in a variety of modified forms, in a scope that does not deviate from the spirit and intent thereof.

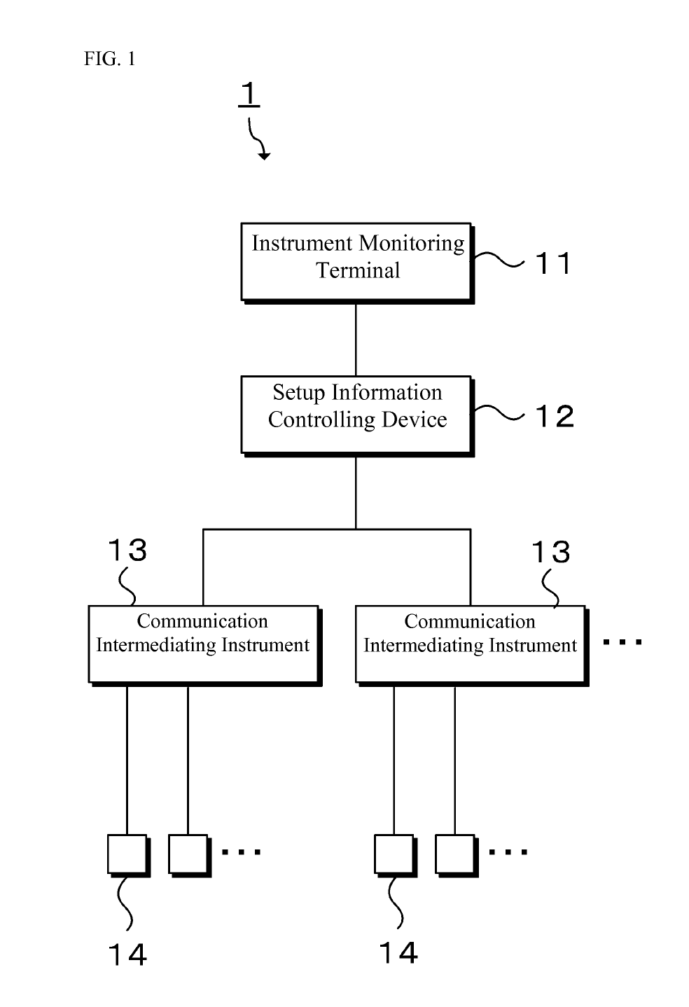

FIG. 1 is a diagram illustrating the structure of an instrument controlling system including a setup information controlling device according to the example according to the present invention. As illustrated in FIG. 1, the instrument controlling system 1 includes an instrument monitoring terminal 11, a setup information controlling device 12, a communication intermediating instrument 13, and a HART communication-compatible instrument 14 that is a lower-level device from the communication intermediating instrument 13. The communication intermediating instrument 13 corresponds to an “instrument” in the present invention. Note that the HART communication-compatible instrument 14 may also be included as an “instrument” according to the present invention.

HART communication-compatible instruments 14 are devices provided within a plant. As HART communication-compatible instruments 14 there are, for example, transmitting devices for transmitting flow rates, pressures, temperatures, and the like, positioners for changing or detecting the amount of opening of valves such as flow rate regulating valves or pressure regulating valves, actuators that operate, for example, pumps and fans, and the like.

A HART communication-compatible instrument 14 is provided with a HART communication function, to send and receive HART communication signals. The HART communication signals are signals produced by superimposing an AC signal wherein logic of a digital signal is converted through assignment to frequencies of 2200 Hz and 1200Hz, onto a DC signal of between 4 and 20 mA.

The DC signal of between 4 and 20 mA is a signal that indicates a single variable value that is set for each HART communication-compatible instrument 14. The variable value is a measurement value such as, for example, a flow rate, a pressure, or a temperature, or a control value such as a degree of valve opening. The digital signals are, for example, signals that correspond to the instrument information including various types of data that is processed within the HART communication-compatible instruments 14. As these types of data there are, for example, process information in the HART communication-compatible instrument 14, or diagnostic information for the hardware that is incorporated into the HART communication-compatible instrument 14. Note that measurement values and control values of the HART communication-compatible instrument 14 may also be included in the instrument information.

By way of illustration, the HART communication-compatible instrument 14 produces a HART communication signal through the following. First the HART communication-compatible instrument 14 converts a digital signal expressed by a specific logic, for example, 0 or 1, into an AC signal by assignment, respectively, to a 2200 Hz frequency signal and a 1200 Hz frequency signal. Following this, the HART communication-compatible instrument 14 superimposes the AC signal, after conversion, onto a DC signal of between 4 and 20 mA that expresses a measured value, a control value, or the like.

The communication intermediating instrument 13 sends and receives HART communication signals to and from HART communication-compatible instruments 14 and also sends and receives digital signals to and from the instrument monitoring terminal 11.

By way of illustration, the communication intermediating instrument 13 generates a DC signal of between 4 and 20 mA and a digital signal from the HART communication signal, as described below. First the communication intermediating instrument 13 separates the HART communication signal which has been received from the HART communication-compatible instrument 14, into an AC signal that combines a 2200 Hz frequency signal and a 1200 Hz frequency signal, and a DC signal of between 4 and 20 mA. Following this, the communication intermediating instrument 13 converts the AC signal, after separation, into digital signals expressed by 0 and 1.

The setup information controlling device 12 is installed between the communication intermediating instrument 13 and the instrument monitoring terminal 11. The setup information controlling device 12 has a function for acquiring and storing, from the instrument monitoring terminal 11, the setup information that is set in each communication intermediating instrument 13, and a function for sending, to each communication intermediating instrument 13, the setup information that has been stored. Note that the detail of the functional structure of the setup information controlling device 12 will be described below.

The setup information includes information regarding the protocol when each communication intermediating instrument 13 communicates with the instrument monitoring terminal 11 or a HART communication-compatible instrument 14. The setup information is, by way of illustration, the local IP address for the communication intermediating instrument 13, the IP address and port number of the instrument monitoring terminal 11, the intervals at which events are to be sent from the communication intermediating instrument 13 to the instrument monitoring terminal 11, the intervals with which events are to be sent from the communication intermediating instrument 13 to the HART communication-compatible instruments 14, the number of transmission retries, the setup status of a master mode indicating whether the communication intermediating instrument 13 is a primary or a secondary, and so forth.

The instrument monitoring terminal 11 stores the setup information that is set in each individual communication intermediating instrument 13. This setup information may be registered through a designer of the instrument controlling system 1 performing an operation on the instrument monitoring terminal 11, or setup information that is stored directly in each individual communication intermediating instrument 13 may be received from the individual communication intermediating instruments 13 and then registered.

Based on the digital signals received from the communication intermediating instrument 13, the instrument monitoring terminal 11 evaluates the state of execution of the processes of the HART communication-compatible instruments 14, failure states of hardware incorporated into the HART communication-compatible instruments 14, required timing for maintenance and repairs of the HART communication-compatible instruments 14, and so forth. The instrument monitoring terminal 11 displays the evaluation results on a monitor (not shown). Doing so enables the administrator to monitor the status of the HART communication-compatible instruments 14.

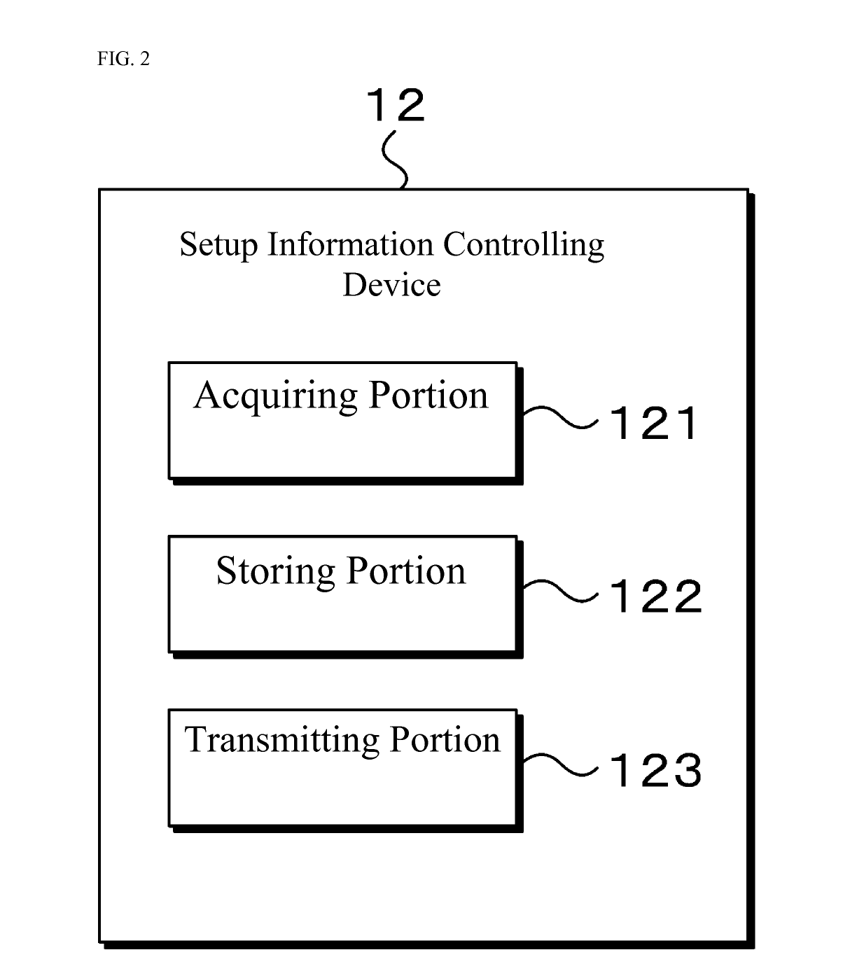

The functional structure of the setup information controlling device 12 will be explained next in reference to FIG. 2. The setup information controlling device 12 functionally has, for example, an acquiring portion 121, a storing portion 122, and a transmitting portion 123.

The acquiring portion 121 acquires, from the instrument monitoring terminal 11, setup information for each of the communication intermediating instruments 13. By way of illustration, the acquiring portion 121 may acquire the setup information by issuing, to the instrument monitoring terminal 11, a command requesting the transmission of the setup information.

The acquiring portion 121 acquires the setup information when the setup information controlling device 12 is started up. As a result, it is possible to acquire the setup information for each of the communication intermediating instruments 13 each time the setup information controlling device 12 is started up.

Note that the timing for acquiring the setup information is not limited to when the setup information controlling device 12 is started up, but rather a notification may be received when the setup information is updated by the instrument monitoring terminal 11 and the setup information may be acquired each time a notification is received, or the setup information may be acquired at regular intervals.

The storing portion 122 stores, in a storage device, the setup information that has been acquired by the acquiring portion 121. The storage device may be, for example, a memory, a memory card, a hard disk, or the like.

The transmitting portion 123 sends the setup information that corresponds to the applicable IP address to the communication intermediating instrument 13 that is connected to the IP address that corresponds to the setup information that is stored by the storing portion 122. By way of illustration, the transmitting portion 123 issues, at regular intervals, retrieval commands to each of the communication intermediating instruments 13, and sends, to a communication intermediating instrument 13 that has replied to the command, setup information corresponding to that instrument. This makes it possible to transmit setup information to a communication intermediating instrument 13 for which a connection to the system has been confirmed.

The transmitting portion 123 stops sending the retrieval commands to a communication intermediating instrument 13 for which the communication of the setup information has been completed, and when a situation arises wherein no connection between the communication intermediating instrument 13 and the system can be confirmed, the issuing of the retrieval command is restarted. This makes it possible to send the setup information each time a communication intermediating instrument 13 is reconnected to the system.

The completion of the transmission of the setup information from the communication intermediating instrument 13 can be evaluated through receiving, from the communication intermediating instrument 13 that has sent the setup information, a setup completed response indicating that the setup of the setup information has been completed. Moreover, if the situation has become one wherein the connection between the communication intermediating instrument 13 and the system cannot be confirmed, this can be evaluated through, for example, by having the communication intermediating instrument 13 that is connected to the system receive, at regular intervals, a heartbeat signal that indicates that the instrument is operating properly, and evaluating that the connection cannot be confirmed if the heartbeat signal is cut off.

Although not illustrated, here the HART communication-compatible instrument 14 in the present example is connected to a controller through an analog input/output instrument. This controller is an instrument for the overall control of the HART communication-compatible instrument 14 that is positioned hierarchically thereunder.

Note that while in the present example the explanation was one wherein the communication intermediating instrument 13 and the analog input/output instrument were equipped separately, there is no limitation thereto, but rather the system may be one wherein the communication intermediating instrument 13 and the analog input/output instrument are equipped integrated in a single unit.

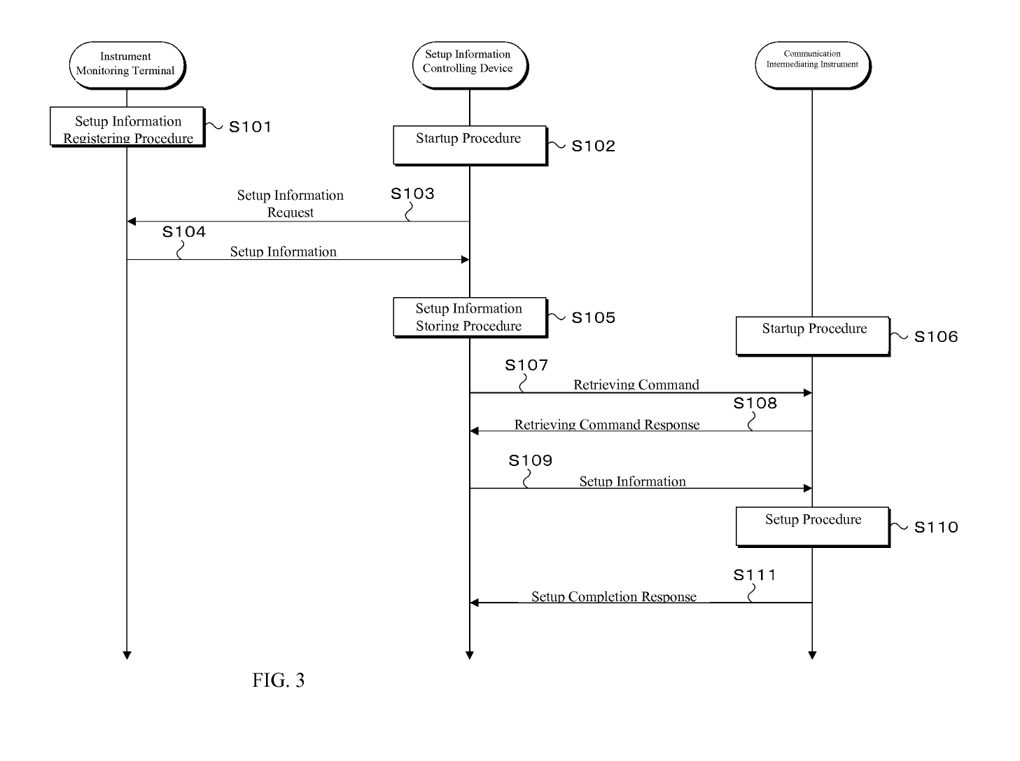

FIG. 3 will be referenced next to explain the operation of the instrument controlling system 1 in the present example.

Firstly, the designer of the instrument controlling system, for example, registers the setup information for a communication intermediating instrument 13 in the instrument monitoring terminal 11 (Step S101).

Following this, when the setup information controlling device 12 is turned ON, the setup information controlling device 12 launches a startup procedure (Step S102). The acquiring portion 121 of the setup information controlling device 12 issues, to the instrument monitoring terminal 11, a command requesting the transmission of the setup information for each individual communication intermediating instrument 13 (Step S103).

Following this, the instrument monitoring terminal 11 sends the setup information for each individual communication intermediating instrument 13 to the setup information controlling device 12 (Step S104). As a result, the acquiring portion 121 of the setup information controlling device 12 acquires setup information for each individual communication intermediating instrument 13.

Following this, the storing portion 122 of the setup information controlling device 12 stores, in the storing device, the setup information acquired by the acquiring portion 121 (Step S105).

On the other hand, when a communication intermediating instrument 13 is turned ON, that communication intermediating instrument 13 launches a startup procedure (Step S106).

The setup information controlling device 12 periodically issues a retrieval command to the communication intermediating instrument 13 that is connected to an IP address corresponding to the setup information that was stored in Step S105, above (Step S107).

Following this, the communication intermediating instrument 13 sends, to the setup information controlling device 12, a response to the retrieval command, if the retrieval command that was issued in Step S107, above, has been received (Step S108).

Following this, the setup information controlling device 12 sends, to the communication intermediating instrument 13 that sent the response in Step S108, setup information corresponding to that communication intermediating instrument 13 (Step S109).

Following this, the communication intermediating instrument 13, based on the setup information that has been received, sets the setup information for that instrument 13 (Step S110).

Following this, the communication intermediating instrument 13, when the setup procedure in Step S110, above, has been completed, sends a setup completed response to the setup information controlling device 12 (Step S111).

As described above, the setup information controlling device 12 according to the present example not only makes it possible to acquire the setup information from the instrument monitoring terminal 11 that stores the setup information for each of the communication intermediating instruments 13, but also possible to send, to a communication intermediating instrument 13 corresponding to the setup information, the setup information that has been stored. Consequently, even if a communication intermediating instrument 13 is swapped due to, for example, a failure, still the setup information that was setup in the communication intermediating instrument 13 prior to the swap can be transferred reliably to the communication intermediating instrument 13 after the swap.

Because of this, the setup information controlling device 12 according to the present example enables the setup information for the communication intermediating instrument 13 to be reproduced easily and accurately.

Note that while, in the example set forth above, the setup information controlling device 12 controlled the setup information of a communication intermediating instrument 13, the setup information that is subject to control is not limited thereto. For example, setup information for a HART communication-compatible instrument 14 that is a lower-level instrument below a communication intermediating instrument 13 may also be included in the setup information that is subject to control.

Moreover, in the example set forth above, the setup information controlling devices 12 may be provided redundantly. Doing so enables improved reliability when controlling the setup information.

Moreover, while in the example set forth above a plurality of communication intermediating instruments 13 were provided below the setup information controlling device 12, the configuration of the setup information controlling devices 12 and the communication intermediating instruments 13 is not limited thereto. For example, the setup information controlling device 12 and a plurality of communication intermediating instruments 13 may be connected in a ring-shaped topology using communication cables, and may be integrated below the instrument monitoring terminal 11.

1. A setup information controlling device connectable to an instrument, which is subject to control, and an instrument monitoring terminal that is provided with the instrument and stores setup information that includes a protocol for communicating with another instrument, the setup information controlling device comprising:
an acquiring portion that acquires the setup information from the instrument monitoring terminal;
a storing portion that stores the setup information that has been acquired by the acquiring portion; and
a transmitting portion that transmits the setup information, corresponding to an address, to the instrument that is connected to that address, which corresponds to the setup information stored in the storing portion.

2. The setup information controlling device as set forth in claim 1, wherein:
the acquiring portion acquires the setup information when the setup information controlling device is turned ON.

3. The setup information controlling device as set forth in claim 1, wherein:
the transmitting portion transmits the setup information to the applicable instrument when a connection to an instrument that is connected to the address corresponding to the setup information that is stored in the storing portion has been confirmed.

4. The setup information controlling device as set forth in claim 1, wherein:
the instrument performs a HART communication that transmits and receives a HART communication signal that is formed through superimposing a first signal and a second signal, and sends and receives the HART communication signal to and from a lower-level instrument that is positioned hierarchically below that instrument.

5. The setup information controlling device as set forth in claim 4, wherein:
the first signal is a DC signal of between 4 and 20 mA and the second signal is an AC signal wherein logic of a digital signal has been assigned and converted into frequency signals of 2200 Hz and 1200 HZ.
